(19) United States
(12) Patent Application Publication
(10) Pub. No.: US 2004/0209525 A1
(43) Pub. Date: Oct. 21, 2004

(54) Modularly expandable housing

(76) Inventors: Michael Konrad, Pfronten (DE); Georg Wolf, Marktoberdorf (DE)

Correspondence Address: BACON & THOMAS, PLLC, 625 SLATERS LANE, FOURTH FLOOR, ALEXANDRIA, VA, 22314

(21) Appl. No.: 10/631,010

(22) Filed: Jul. 31, 2003

(30) Foreign Application Priority Data
Jul. 31, 2002 (DE) 202 11 822.3

(51) Int. Cl. H01R 13/502

(52) U.S. Cl. 439/701

(57) ABSTRACT

The invention relates to a modularly expandable housing, of the type referred to as a top-hat rail housing, which is used in the process measurement/process control technologies. The housing exhibits a predetermined number of receiving slots. A corresponding number of insertion modules is provided, which are insertable into the receiving slots. Each insertion module has a releasable locking device, by way of which each insertion module is lockable in a receiving slot or removable from the receiving slot.

The invention relates to a modularly expandable housing. Especially, it concerns a housing of the type referred to as a top-hat rail housing, which is used in the process measurement/process control technologies.

The applicant markets different types of process transmitters under the trademark PRELINE for a wide variety of applications. An example is the process transmitter PRELINE RMA 422 which is a multifunctional, 1-2 channel, top-hat rail device with intrinsically safe current input and measurement converter power supply, limit value or, alarm set point, monitoring, mathematics functions and 1-2 analog outputs. Among its uses, this known process transmitter serves for temperature display and temperature monitoring, for process data acquisition and process monitoring, for process control, for signal conditioning and signal conversion, as well as signal doubling. It is capable of forming new process parameters through the use of calculation operations (addition, subtraction, multiplication) on the input signals. The known transmitter has scalable analog outputs for current and voltage, a serial interface for data exchange, a liquid crystal display and pushbuttons for local operation and local display.

In the case of complex applications, e.g. when the signals from a number of field apparatuses must be processed, it is usual that several process transmitters are required. The individual transmitters must then be secured on the top-hat rail, and, according to the known solutions, this requires that tools be used.

An object of the invention is to provide a modularly expandable housing, that can be fitted in simple way and manner to different demands in the process measurement/process control technologies.

The object is solved, in that the housing exhibits a predetermined number of receiving shafts, a corresponding number of insertion modules is provided, which are insertable into the receiving shafts, and each insertion module has a releasable locking device, by way of which each insertion module is lockable in a receiving shaft or removable from the receiving shaft. According to an advantageous further development of the housing of the invention, it is provided that the locking device is provided, respectively, in the lower region of each insertion module and on the base surface of the housing. The locking device can be formed especially simply, when it is embodied as a snap connection. For this purpose, according to an advantageous embodiment, there are two engagement elements, especially two snap hooks, provided on the base surface of the insertion module. These engage in the locking position in two corresponding recesses in the base surface of the housing.

An advantageous embodiment of the housing of the invention provides that the insertion module is a plug-in card module or a blind, or dummy, module. In the case of the plug-in card module, such can e.g. be a module for calculating and/or display of a process or control parameter, a module for connecting the sensor to a bus, or a network part.

The invention is explained in greater detail on the basis of the following drawings, which show as follows:

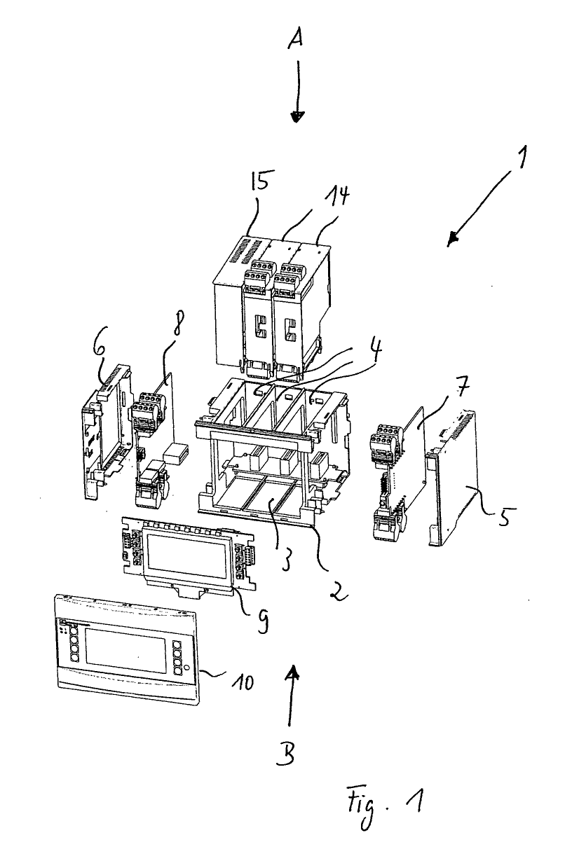

FIG. 1: an exploded view of a preferred embodiment of the housing of the invention;

FIG. 2: an exploded view of the support frame, with two plug-in card modules and one blind module;

FIG. 3: an exploded view of the support frame with one plug-in card module;

FIG. 4: a plan view of the housing in the direction of arrow A in FIG. 1;

FIG. 5: a plan view of the housing in the direction of arrow B in FIG. 1; and

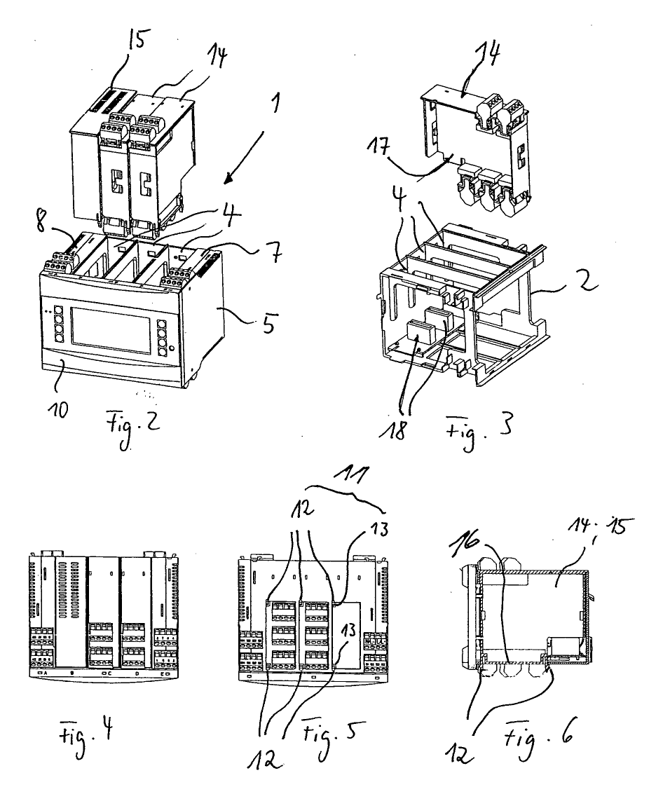

FIG. 6: a side view of a plug-in card module or a blind module.

FIGS. 1 to 5 illustrate in different views a preferred embodiment of the modularly constructed top-hat rail housing 1 of the invention. FIG. 1 shows an exploded view of a preferred embodiment of the housing 1 of the invention, while FIG. 2 is an exploded view of the assembled housing 1 and the insert modules 14, 15. FIG. 3 concerns an exploded view of the support frame 3 and only one plug-in card module 14, 15. FIG. 4 provides a plan view of the housing 1 in the direction of arrow A of FIG. 1, while FIG. 5 shows a plan view of the housing 1 in the direction of arrow B of FIG. 1. FIG. 6 presents a side view of a plug-in card module 14 or blind module 15. Housing 1 of the invention is provided, for example, for a steam- or heat-quantities calculator. Such calculators are used in the energy industry, in the chemical and pharmaceutical industries, in the foods industry, in heating and air conditioning technology, and in plant and equipment construction.

Housing 1 has three insertion shafts 4 for receiving a maximum of three insertion modules 14. The insertion modules 14 can be plug-in card modules, which can serve e.g. for calculating and/or display of a process or control parameter, or for connecting a sensor to a bus. Also, the plug-in card module can be a network part. In case the number of receiving shafts 4 exceeds the number of required insertion modules 14, a blind module 15 is provides as a place holder.

Housing 1 has a support frame 2 with three receiving shafts 4. The two side walls 5, 6 with the circuit cards 7, 8 secured thereon can be connected to the support frame 2 with click connectors. Display board 9 is connected on the front of the support frame 2. Front frame 10 is positioned in front of the display board 9. Especially, the display unit is a liquid crystal display. The insertion modules 14; 15 are individually positionable and lockable in the receiving shafts 4 of the support frame 2.

An insertion module 14; 15 is inserted from above into one of the receiving shafts 4. On the base surface or underside of the insertion module 14, 15 are two flexible snap hooks 12, which engage in corresponding recesses 13 on the base surface 3 of housing 1. By pressing both snap hooks 12 of an insertion module 14, 15 together, the locking is released in simple manner and the insertion module 14, 15 can then be removed by simply pulling it from the receiving shaft 4. To make electrical contact, the board tongue 17 on an insertion module 14, 15 engages in the plug-in connector 18 of the bus board.

### List of Reference Symbols

1 housing of the invention

2 support frame

3 base surface of the housing

4 receiving shaft

5 side wall

6 side wall

7 circuit card

8 circuit card

9 display board

10 front frame

11 locking device/snap connection

12 engaging element/snap hook

13 recess

14 insertion module/plug-in card module

15 blind module

16 base surface of the insertion module

17 board tongue

18 plug-in connector on bus board

1-8. (Canceled).

9. A modularly expandable housing, for use in process measurement/process control technologies, having: a predetermined number of receiving slots for receiving a corresponding number of insertion modules; and a releasable locking device, by way of which each insertion module is lockable in a receiving slot or removable from said receiving slot.

10. The modularly expandable housing as claimed in claim 9, wherein said locking device is provided, respectively, in the lower region of each insertion module and on said base surface of said housing.

11. The modularly expandable housing as claimed in claim 9, wherein said releasable locking device is a snap connection.

12. The modularly expandable housing as claimed in claim 9, wherein each insertion module has a base surface, and wherein two engagement elements provided on the base surface of the insertion module, which engage in the locking position in two corresponding recesses in said base surface of said housing.

13. The modularly expandable housing as claimed in claim 9, wherein the insertion module is one of: a plug-in card module and a blind module.

14. The modularly expandable housing as claimed in claim 13, wherein the plug-in card module is a module for calculating and/or display of a process or control parameter.

15. The modularly expandable housing as claimed in claim 13, wherein the plug-in card module is a module for connecting the sensor to a bus.

16. The modularly expandable housing as claimed in claim 13, wherein the plug-in card module is a network part.

17. The modularly expandable housing as claimed in claim 10, wherein said releasable locking device is a snap connection.

18. The modularly expandable housing as claimed in claim 10, wherein each insertion module has a base surface, and wherein two engagement elements provided on the base surface of the insertion module, which engage in the locking position in two corresponding recesses in said base surface of said housing.

19. The modularly expandable housing as claimed in claim 9, wherein said housing is a top-hat rail housing.
